(19) United States
(12) Patent Application Publication
(10) Pub. No.: US 2025/0163272 A1
(43) Pub. Date: May 22, 2025

(54) METHOD FOR PRODUCING AN AQUEOUS EMULSION OF POLYESTER

(71) Applicant: KAO CORPORATION, Tokyo (JP)

(72) Inventors: Machiko IE-KONO, High Point, NC (US); Mohand MELBOUCI, High Point, NC (US); Martin THOMPSON, High Point, NC (US); Eiji SHIRAI, Tokyo (JP)

(73) Assignee: KAO CORPORATION, Tokyo (JP)

(21) Appl. No.: 18/954,605

(22) Filed: Nov. 21, 2024

Related U.S. Application Data
(60) Provisional application No. 63/601,781, filed on Nov. 22, 2023.

(51) Int. Cl. C08L 95/00; C08J 3/05

(52) U.S. Cl. CPC C08L 95/005; C08J 3/05; C08J 2367/02; C08L 2201/52; C08L 2555/80

(57) ABSTRACT

The present invention provides: a method for producing an aqueous emulsion of a polyester, the method including adding an aqueous dispersion of a polyester to a soap solution of a cationic surfactant, the polyester in the aqueous dispersion having a negative value zeta potential; and an aqueous emulsion of a polyester, containing an a polyester and a cationic surfactant, particles containing the polyester having a positive value zeta potential and a volume average particle diameter of ≤300 nm.

### FIELD OF THE INVENTION

The present invention relates to a method for producing an aqueous emulsion of a polyester and an aqueous emulsion of a polyester.

### BACKGROUND OF THE INVENTION

Asphalt pavement using an asphalt mixture has been performed for paving highways, driveways, parking spaces, cargo yards, sidewalks, etc. because of relatively easy construction and a short period of time from beginning of paving works to traffic start. In the asphalt pavement, a road surface is formed from an asphalt mixture in which aggregate particles are bonded via asphalt, and thus, the paved road has a good hardness and durability.

However, surface aggregate separation (raveling) and crack generation occur at the surface of asphalt pavements due to degradation, but the longevity of the asphalt pavement can be prolonged by conducting regular maintenance to prevent severe deformation (ruts), cracks, aggregate separation, potholes, etc. that would otherwise require re-surfacing. An asphalt emulsion is used for such regular maintenance and many other applications. It is useful for stabilizing a paved layer, for example, through the following various surface treatments: slurry sealing, micosurfacing, chip sealing, fog sealing, recycling (cold mix, cold in-place). An asphalt emulsion is basically produced by emulsifying asphalt as an oil phase and soap solution (water and an emulsifier) as an aqueous phase. For the purpose of enhancing the durability of the paved layer containing an asphalt emulsion, a resin emulsion, such as SBR, might be incorporated into the soap solution or asphalt phase or post-added to the asphalt emulsion in the production of the asphalt emulsion.

For example, JP 2022-112509 A (PTL 1) discloses, as a polyester emulsion for modifying an asphalt for obtaining an asphalt superior in weather resistance, a polyester emulsion for modifying an asphalt, containing polyester particles having a volume median particle diameter (D₅₀) of 20 nm or more and 500 nm or less and water.

### SUMMARY OF THE INVENTION

The present invention relates to a method for producing an aqueous emulsion of a polyester (A), the method including adding an aqueous dispersion of a polyester (A) to an aqueous solution of a cationic surfactant (B), the polyester (A) in the aqueous dispersion having a zeta potential of a negative value.

### DETAILED DESCRIPTION OF THE INVENTION

Cationic emulsions occupy 70% or more of the asphalt emulsion market, and production of a cationic polyester emulsion is required for adding an aqueous emulsion of a polyester into a cationic asphalt emulsion system. However, since polyester which is a polycondensate of an alcohol and a carboxylic acid has a carboxylic acid group and a carboxylic acid salt represents an anionic type, any ingenuity is required for producing a cationic polyester emulsion.

In the polyester emulsion for modifying an asphalt described in PTL 1, it is required to introduce a certain amount or more of a polyalkylene glycol-derived structure into a polyester contained in the emulsion, and thus, the glass transition temperature of the polyester is a negative value and there has been room for improvement particularly in the water abrasion resistance (wet track) of asphalt pavement constructed with the polyester emulsion.

In the present invention, a polyester emulsion of an anionic carboxylic acid salt is produced first for emulsifying a polyester. The polyester emulsion of a carboxylic acid salt is added to an aqueous solution of a cationic surfactant having a concentration of a certain level or more to thus allow two molecules of the cationic surfactant to adsorb onto the carboxylic acid salt, whereby it has become possible to produce a stable cationic aqueous emulsion of a polyester. In the production method of the present application, since incorporation of a polyalkylene glycol-derived structure is not required, it has become possible to produce a cationic aqueous emulsion of a polyester in a wide variety of resin designs. In addition, since incorporation of a polyalkylene glycol-derived structure is not required, it has become possible to design an emulsion having a higher glass transition temperature and it has become possible to provide a cationic aqueous emulsion of a polyester that can provide an asphalt emulsion providing asphalt pavement superior in the water abrasion resistance. Although the mechanism is not clear, supposedly because the aqueous emulsion of the polyester on which two molecules of the cationic surfactant adsorb also has a good film formability, an asphalt emulsion providing asphalt pavement also having a fuel resistance can be provided.

The present invention relates to the following (1) and (2).

(1) A method for producing an aqueous emulsion of a polyester (A), the method comprising adding an aqueous dispersion of a polyester (A) to an aqueous solution of a cationic surfactant (B),
the polyester (A) in the aqueous dispersion having a zeta potential of a negative value. (2) An aqueous emulsion of a polyester (A), comprising a polyester (A) and a cationic surfactant (B),
particles containing the polyester (A) having a zeta potential of a positive value and a volume average particle diameter of 300 nm or less.

### [Method for Producing Aqueous Emulsion of Polyester (A)]

A method for producing an aqueous emulsion of a polyester (A) according to an aspect of the present invention includes adding an aqueous dispersion of a polyester (A) to a cationic soap solution (B), and the polyester (A) in the aqueous dispersion has a zeta potential of a negative value.

The present inventors have found that asphalt pavement constructed with an asphalt emulsion emulsified with an aqueous emulsion of a polyester (A) obtained by a production method according to an aspect of the present invention has a superior fuel resistance and water abrasion resistance.

Thus, it is considered that asphalt pavement constructed by using an asphalt emulsified with an aqueous emulsion of a polyester (A) obtained by a production method according to an aspect of the present invention has a superior fuel resistance and water abrasion resistance.

Definitions and the like of various terms in this description will be shown below.

In a polyester, the “alcohol component-derived structural unit” means a structure obtained by eliminating a hydrogen atom from a hydroxy group of the alcohol component, and the “carboxylic acid component-derived structural unit” means a structure obtained by eliminating a hydroxy group from a carboxylic group of the carboxylic acid component.

The “carboxylic acid component” has a concept including not only the carboxylic acid but also the anhydride which decomposes in a reaction to produce the acid, and an alkyl ester of the carboxylic acid (the number of carbon atoms of the alkyl group is, for example, 1 or more and 3 or less). When the carboxylic acid component is an alkyl ester of the carboxylic acid, the number of carbon atoms of the carboxylic acid does not include the number of carbon atoms of the alkyl group that is an alcohol residue of the ester.

The “≤A” and “≥B” mean “A or less” and “B or more”, respectively.

### <Polyester (A)>

In a production method according to an aspect of the present invention, the polyester (A) is a polycondensate of an alcohol component and a carboxylic acid component, containing a structural unit derived from the alcohol component and a structural unit derived from the carboxylic acid component.

Properties and the like of the alcohol component, the carboxylic acid component, and the polyester (A) will be described below.

### (Alcohol Component)

Examples of the alcohol component include an aliphatic diol, an alicyclic diol, an aromatic diol, and a trihydric or higher polyhydric alcohol. Each of the alcohol components can be used alone or two or more thereof can be used in combination.

The aliphatic diol is preferably a linear or branched aliphatic diol having a main chain having 2 or more and 12 or less carbon atoms, and more preferably a linear or branched aliphatic diol having a main chain having 2 or more and 8 or less carbon atoms.

The aliphatic diol is preferably a saturated aliphatic diol.

Specific examples of the aliphatic diol include ethylene glycol, 1,2-propanediol, 1,3-propanediol, 1,3-butanediol, 1,4-butanediol, 1,4-butenediol, 1,5-pentanediol, 1,6-hexanediol, neopentyl glycol, 1,10-decanediol, and 1,12-dodecanediol.

Examples of the alicyclic diol include hydrogenated bisphenol A (2,2-bis(4-hydroxycyclohexyl)propane), an alkylene oxide adduct of hydrogenated bisphenol A, cyclohexanediol, and cyclohexanedimethanol.

Examples of the aromatic diol include bisphenol A (2,2-bis(4-hydroxyphenyl)propane) and an alkylene oxide adduct of bisphenol A. An example of the alkylene oxide adduct of bisphenol A is an alkylene oxide adduct of bisphenol A represented by the following formula (I).

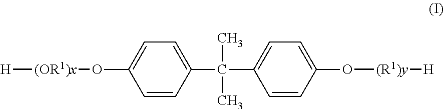

In the formula (I), OR¹ and R¹O are an alkylene oxide, R¹ is an alkylene group having 2 or 3 carbon atoms, x and y represent a positive number indicating an average number of moles of alkylene oxides added, and the sum of x and y is preferably ≥1, more preferably ≥1.5, and preferably ≤16, more preferably ≤8, further preferably ≤4.

Examples of the alkylene oxide adduct of bisphenol A represented by the formula (I) include a propylene oxide adduct of bisphenol A and an ethylene oxide adduct of bisphenol A. Each of the alkylene oxide adducts of bisphenol A can be used alone or two or more thereof can be used in combination.

The trihydric or higher polyhydric alcohol is preferably a trihydric alcohol. Examples of trihydric or higher polyhydric alcohol include glycerol, pentaerythritol, trimethylolpropane, and sorbitol.

From the viewpoint of controlling properties, the alcohol component can further contain a monohydric aliphatic alcohol. Examples of the monohydric aliphatic alcohol include lauryl alcohol, myristyl alcohol, palmityl alcohol, and stearyl alcohol. Each of the monohydric aliphatic alcohols can be used alone or two or more thereof can be used in combination.

### (Carboxylic Acid Component)

Examples of the carboxylic acid component include an aliphatic dicarboxylic acid, an aromatic dicarboxylic acid, and a tribasic or higher and hexabasic or lower polybasic carboxylic acid. Each of the carboxylic acid components can be used alone or two or more thereof can be used in combination.

Examples of the aliphatic dicarboxylic acid include aliphatic dicarboxylic acids with a main chain having preferably ≥4 and preferably ≤14 carbon atoms, such as fumaric acid, maleic acid, oxalic acid, malonic acid, citraconic acid, itaconic acid, glutaconic acid, succinic acid, adipic acid, suberic acid, azelaic acid, sebacic acid, dodecanedioic acid, a succinic acid substituted with an alkyl group having ≥1 and ≤20 carbon atoms or an alkenyl group having ≥2 and ≤20 carbon atoms, anhydrides thereof, and alkyl esters thereof (the number of carbon atoms of the alkyl group is, for example, ≥1 and ≤3). Examples of the substituted succinic acid include dedocylsuccinic acid, dodecenylsuccinic acid, and octenylsuccinic acid.

Examples of the aromatic dicarboxylic acid include phthalic acid, terephthalic acid, isophthalic acid, naphthalene dicarboxylic acid, anhydrides thereof, and alkyl esters thereof (the number of carbon atoms of the alkyl group is, for example, ≥1 and ≤3 or less). Among the aromatic dicarboxylic acids, from the viewpoints of the fuel resistance and water abrasion resistance of asphalt pavement, isophthalic acid and terephthalic acid are preferred, and terephthalic acid is more preferred.

The tribasic or higher and hexabasic or lower polybasic carboxylic acid is preferably a tribasic carboxylic acid. Examples of the tribasic or higher and hexabasic or lower polybasic carboxylic acid include trimellitic acid, 2,5,7-naphthalene tricarboxylic acid, pyromellitic acid, and acid anhydrides thereof.

### (Polyethylene Terephthalate-Derived Structural Unit)

The polyester (A) can contain an ethylene glycol-derived structural unit and a terephthalic acid-derived structural unit that are derived from polyethylene terephthalate (PET). The polyethylene terephthalate may contain, besides the ethylene glycol-derived structural unit and the terephthalic acid-derived structural unit, a small amount of butanediol, isophthalic acid, or other components. The polyethylene terephthalate is preferably a collected polyethylene terephthalate.

The content of polyethylene terephthalate in the raw materials of the polyester (A) is, from the viewpoints of the fuel resistance and the in-water abrasion resistance of asphalt pavement, preferably ≥10% by mass, more preferably ≥20% by mass, further preferably ≥30% by mass, and preferably ≤60% by mass, more preferably ≤50% by mass.

In a preferred aspect of the polyester (A), from the viewpoint of interacting with asphaltene in an asphalt to further increase deflection resistance, the content of the alkylene oxide adduct of bisphenol A as an alcohol relative to the polyester (A) is preferably ≥20% by mass, further preferably 30% by mass or more, and preferably ≤80% by mass.

The polyester (A) may be a polyester modified to the extent that the characteristics thereof are not substantially impaired. Specific examples of modified polyester include polyesters grafted or blocked with phenol, urethane, epoxy, or the like by a method described in JP11-133668A, JP10-239903A, JP8-20636A, and the like. A preferred example of modified polyester is a urethane-modified polyester obtained by urethane-extending a polyester with a polyisocyanate compound.

In addition, the polyester (A) may be a polyester that is designed to have a polyester segment and an additional polymer segment (hereinafter also referred to as “composite polyester”).

An example of the polyester segment of the composite polyester is a polycondensate of such an alcohol component and a carboxylic acid component as described above. An example of the addition polymer segment of the composite polyester is an addition polymer of a raw monomer having a carbon-carbon unsaturated bond containing a styrene compound.

The composite polyester preferably has a polyester segment, an additional polymer segment, and a structural unit that can be covalently bonded to both the segments. Examples of the structural unit that can be covalently bonded to a polyester segment include a hydroxy group, a carboxy group, an epoxy group, a primary amino group, a secondary amino group, and an ester group. An example of the structural unit that can be covalently bonded to an addition polymer segment is a carbon-carbon unsaturated bond (ethylenically unsaturated bond).

An example of the styrene compound is an unsubstituted or substituted styrene. Examples of the substituent substituted on styrene include an alkyl group having ≥1 and ≤5 carbon atoms, a halogen atom, an alkoxy group having ≥1 and ≤5 carbon atoms, and a sulfonate group or a salt thereof.

Examples of the styrene compound include styrene, methylstyrene, α-methylstyrene, β-methylstyrene, tert-butylstyrene, chlorostyrene, chloromethylstyrene, methoxystyrene, and styrenesulfonic acid or a salt thereof. Among them, styrene is preferred.

In the raw monomers of the addition polymer segment, the content of the styrene compound is preferably ≥40% by mass, more preferably ≥50% by mass, further preferably ≥55% by mass, and preferably ≤95% by mass, more preferably ≤90% by mass, further preferably ≤85% by mass.

Examples of the raw monomer other than the styrene compound include (meth)acrylate esters, such as an alkyl (meth)acrylate, benzyl (meth)acrylate, and dimethylaminoethyl (meth)acrylate; olefins, such as ethylene, propylene, and butadiene; a halovinyl, such as vinyl chloride; vinyl esters, such as vinyl acetate and vinyl propionate; a vinyl ether, such as methyl vinyl ether; a halogenated vinylidene, such as vinylidene chloride; and an N-vinyl compound, such as N-vinyl pyrrolidone. Among them, an alkyl (meth)acrylate is preferred.

The number of carbon atoms of the alkyl group in the alkyl (meth)acrylate is preferably ≥1, more preferably ≥2, further preferably ≥3, and preferably ≤24, more preferably ≤22, further preferably ≤20.

Examples of the alkyl (meth)acrylate include methyl (meth)acrylate, ethyl (meth)acrylate, (iso)propyl (meth)acrylate, (iso- or tert-)butyl (meth)acrylate, (iso)amyl (meth)acrylate, cyclohexyl (meth)acrylate, 2-ethylhexyl (meth)acrylate, (iso)octyl (meth)acrylate, (iso)decyl (meth)acrylate, (iso)dodecyl (meth)acrylate, (iso)palmityl (meth)acrylate, (iso)stearyl (meth)acrylate, and (iso)behenyl (meth)acrylate. The alkyl (meth)acrylate is preferably an ester of (meth)acrylic acid and a branched alkyl alcohol, and more preferably 2-ethylhexyl (meth)acrylate and butyl (meth)acrylate.

In the raw monomers of the addition polymer segment, the content of the (meth)acrylate ester is preferably ≥5% by mass, more preferably ≥10% by mass, further preferably ≥15% by mass, and preferably ≤60% by mass, more preferably ≤50% by mass, further preferably ≤45% by mass.

In the raw monomers of the addition polymer segment, the total amount of the styrene compound and the (meth)acrylate ester is preferably ≥80% by mass, more preferably ≥90% by mass, further preferably ≥95% by mass, further preferably 100% by mass.

The composite polyester preferably has a structural unit derived from a bireactive monomer bonded to a polyester segment and an additional polymer segment via a covalent bond.

The “bireactive monomer-derived structural unit” means a unit obtained by a reaction of a functional group and an addition polymerizable group of the bireactive monomer.

Examples of the addition polymerizable group include a carbon-carbon unsaturated bond (ethylenically unsaturated bond).

An example of the bireactive monomer is an addition polymerizable monomer having in the molecule at least one functional group selected from a hydroxy group, a carboxy group, an epoxy group, a primary amino group, a secondary amino group, and an ester group. Among them, from the viewpoint of the reactivity, an addition polymerizable monomer having at least one functional group selected from a hydroxy group and a carboxy group is preferred, and an addition polymerizable monomer having a carboxy group and an addition polymerizable monomer having an ester group are more preferred.

Examples of the addition polymerizable monomer having a carboxy group include (meth)acrylic acid, 2-methyl-3-butenoic acid, and 4-pentenoic acid. Among them, from the viewpoint of the reactivities of both a polycondensation reaction and an addition polymerization reaction, (meth)acrylic acid is preferred, and acrylic acid is more preferred.

Examples of the addition polymerizable monomer having an ester group include esters of acrylic acid, 2-methyl-3-butenoic acid, 4-pentenoic acid, and the like. A part or all of the addition polymerizable monomer having an ester group undergoes a transesterification reaction with an alcohol component contained in the polyester segment to thereby form a covalent bond to the polyester segment, and a carbon-carbon unsaturated bond in the addition polymerizable monomer having an ester group undergoes an addition polymerization reaction with the raw monomer of the addition polymer segment to thereby form a covalent bond to the addition polymer segment. The residue of the addition polymerizable monomer having an ester group which has not undergone the transesterification reaction with the alcohol component is a raw monomer of the addition polymer segment.

Thus, among the addition polymerizable monomers having an ester group, from the viewpoint of the reactivities of both the transesterification reaction and the addition polymerization reaction, the alkyl acrylate that is mentioned as the raw monomer of the addition polymer segment in which the alkyl group is derived from a primary alcohol is preferred, and butyl acrylate is more preferred.

When the bireactive monomer is at least one or more selected from an addition polymerizable monomer having a carboxy group and an addition polymerization monomer having an ester group, the amount of the bireactive monomer-derived structural unit relative to 100 parts by mole of the alcohol component of the polyester segment is preferably ≥1 part by mole, more preferably ≥2 parts by mole, further preferably ≥2.5 parts by mole, and preferably ≤15 parts by mole, more preferably ≤10 parts by mole, further preferably ≤5 parts by mole.

### (Method for Producing Polyester (A))

The method for producing polyester (A) is not particularly limited, but, for example, the polyester may be produced by a method including subjecting an alcohol component and a carboxylic acid component to polycondensation. When polyester (A) is a composite polyester, the polyester may be produced by a method including subjecting the alcohol component and the carboxylic acid component to polycondensation and subjecting a raw monomer of an addition polymer segment and a bireactive monomer to addition polymerization.

Subjecting the raw monomer of the addition polymer segment and the bireactive monomer to addition polymerization may be performed after subjecting the alcohol component and the carboxylic acid component to polycondensation, subjecting the alcohol component and the carboxylic acid component to polycondensation may be performed after subjecting the raw monomer of the addition polymer segment and the bireactive monomer to addition polymerization, or subjecting the alcohol component and the carboxylic acid component to polycondensation and subjecting the raw monomer of the addition polymer segment and the bireactive monomer to addition polymerization may be performed at the same time.

In a preferred method, a part of the carboxylic acid component is subjected to a polycondensation reaction in subjecting the alcohol component and the carboxylic acid component to polycondensation, followed by subjecting the raw monomer of the addition polymer segment and the bireactive monomer to addition polymerization, and then, the residue of the carboxylic acid component is added to the polymerization system to further promote the polycondensation reaction of subjecting the alcohol component and the carboxylic acid component to polycondensation and the polycondensation reaction with the bireactive monomer or a carboxy group of a bireactive monomer-derived structural unit.

When polyester (A), used in the present invention, contains a structural unit derived from polyethylene terephthalate-derived ethylene glycol and a structural unit derived from polyethylene terephthalate-derived terephthalic acid, the amount of polyethylene terephthalate present in the raw materials is, in the total amount of the polyethylene terephthalate, the alcohol component, and the carboxylic acid component, preferably ≥5% by mass, more preferably ≥10% by mass, further preferably ≥30% by mass, and preferably ≤80% by mass, more preferably ≤70% by mass, further preferably ≤60% by mass.

By adding polyethylene terephthalate in the polycondensation reaction of the alcohol component and the carboxylic acid component, a transesterification reaction occurs, and a polyester (A) in which the structural unit of the polyethylene terephthalate is taken in the alcohol component-derived structural unit and the carboxylic acid component-derived structural unit can be obtained. The polyethylene terephthalate may be present from the beginning of the polycondensation reaction or may be added to the reaction system during the polycondensation reaction.

In the polycondensation reaction, from the viewpoint of reaction rate, an esterification catalyst can be used. An example of the esterification catalyst is a tin (II) compound having no Sn—C bond, such as tin (II) di(2-ethylhexanoate). The amount of the esterification catalyst used is, from the viewpoint of the reaction rate, relative to 100 parts by mass of the total amount of the polyethylene terephthalate, the alcohol component, and the carboxylic acid component, preferably ≥0.01 parts by mass, more preferably ≥0.1 parts by mass, further preferably ≥0.2 parts by mass, and preferably ≤1.5 parts by mass, more preferably ≤1.0 parts by mass, further preferably ≤0.6 parts by mass.

In the polycondensation reaction, in addition to the esterification catalyst, a promoter can be used. An example of the promoter is a pyrogallol compound, such as gallic acid. The amount of the promoter used is, relative to 100 parts by mass of the total amount of the alcohol component and the carboxylic acid component, preferably ≥0.001 parts by mass, more preferably ≥0.005 parts by mass, further preferably ≥0.01 parts by mass, and preferably ≤0.15 parts by mass, more preferably ≤0.10 parts by mass, further preferably ≤0.06 parts by mass.

Examples of a radical polymerization initiator for the addition polymerization in subjecting the raw monomer of the addition polymer segment and the bireactive monomer to addition polymerization include a peroxide, such as di-tert-butyl peroxide, a persulfate salt, such as sodium persulfate, and an azo compound, such as 2,2′-azobis(2,4-dimethylvaleronitrile).

The amount of the radical polymerization initiator used relative to 100 parts by mas of the raw monomer of the addition polymer segment is preferably ≥1 part by mass and ≤20 parts by mass.

The temperature in the addition polymerization is preferably ≥110° C., more preferably ≥130° C., and preferably ≤230° C., more preferably ≤220° C., further preferably ≤210° C.

### (Properties of Polyester (A))

The softening point of the polyester (A) is, from the viewpoints of the fuel resistance and the in-water abrasion resistance of asphalt pavement, preferably ≥20° C. or higher, more preferably ≥30° C., further preferably ≥40° C., and preferably ≤140° C., more preferably ≤130° C., further preferably ≤125° C.

The glass transition temperature of the polyester (A) is, from the viewpoints of the fuel resistance and water abrasion resistance of asphalt pavement, preferably ≥10° C., more preferably ≥15° C., further preferably ≥20° C., and preferably ≤90° C., more preferably ≤80° C., further preferably ≤70° C. For making the glass transition temperature of the polyester (A) within the above range, the polyester (A) does preferably not contain the structural units derived from polyalkylene glycol. Here, the structural units derived from polyalkylene glycol is a structure unit derived only from polyalkylene glycol, and does not include a structural unit in which an alkylene oxide in added to another structure, such as alkylene oxide adduct of bisphenol A.

The acid value of the polyester (A) is, from the viewpoints of the fuel resistance and the in-water abrasion resistance of asphalt pavement, preferably ≥4 mgKOH/g, more preferably ≥5 mgKOH/g, further preferably ≥6 mgKOH/g, and preferably ≤50 mgKOH/g, more preferably ≤40 mgKOH/g, further preferably ≤30 MGk OH/g.

The hydroxyl value of the polyester (A) is, from the viewpoints of the fuel resistance and the in-water abrasion resistance of asphalt pavement, preferably ≥5 mgKOH/g, more preferably ≥10 mgKOH/g, further preferably ≥15 mgKOH/g, and preferably ≤50 mgKOH/g, more preferably ≤40 mgKOH/g, further preferably ≤35 mgKOH/g.

The number average molecular weight Mw of the polyester (A) is, from the viewpoints of the fuel resistance and the in-water abrasion resistance of asphalt pavement, preferably ≥1,500, more preferably ≥1,800, further preferably ≥2,000, and preferably ≤9,000, more preferably ≤7,000, further preferably ≤5,000.

The weight average molecular weight Mw of the polyester (A) is, from the viewpoints of the fuel resistance and the in-water abrasion resistance of asphalt pavement, preferably ≥5,000, more preferably ≥6,000, further preferably ≥7,000, and preferably ≤100,000, more preferably ≤80,000, further preferably ≤50,000.

The softening point, the glass transition temperature, the acid value, the hydroxyl value, the number average molecular weight Mn, and the weight average molecular weight Mw of the polyester (A) can be measured by methods described in the section of Examples. The softening point, the glass transition temperature, the acid value, the hydroxyl value, the number average molecular weight Mn, and the weight average molecular weight Mw can be controlled by the composition of the raw monomers, the molecular weight, the amount of the catalyst, or the reaction conditions.

### <Cationic Surfactant (B)>

In a production method according to an aspect of the present invention, examples of the cationic surfactant (B) include an alkylamine salt, an alkanolamine salt, a quaternary ammonium salt, an amine oxide, and a polyethylene polyamine, and ethylene oxide and propylene oxide adducts thereof are also included. The cationic surfactant (B) preferably has at least one quaternary ammonium salt moiety in the molecule.

Into the cationic surfactant (B), in terms of the form of the surfactant, for example, for the purpose of making a liquid form, a solvent, such as water, a lower alcohol, glycol, and polyoxyethylene glycol, a saccharide, such as glucose and sorbitol, a lower fatty acid, a lower amine, a hydrotropic agent, such as p-toluenesulfonic acid and an ether carboxylic acid, or the like can be blended.

The mass ratio of the cationic surfactant (B) to the polyester (A) (cationic surfactant (B)/polyester (A)) after adding the entire aqueous dispersion of the polyester (A) to the aqueous solution of the cationic surfactant (B) is, from the viewpoints of the fuel resistance and the water abrasion resistance of asphalt pavement, preferably ≥10/100, more preferably ≥11/100, further preferably ≥12/100, and preferably ≤30/100, more preferably ≤20/100.

The mass ratio of the cationic surfactant (B) to the polyester (A) is preferably adjusted so that the zeta potential of particles containing the polyester (A) after adding an aqueous dispersion of a polyester (A) to an aqueous solution of a cationic surfactant (B) is a positive value.

### [Adding Aqueous Dispersion of Polyester (A) to Aqueous Solution of Cationic Surfactant (B)]

A method for producing an aqueous emulsion of a polyester (A) according to an embodiment of the present invention includes adding an aqueous dispersion of a polyester (A) to an aqueous solution of a cationic surfactant (B). In adding an aqueous dispersion of a polyester (A) to an aqueous solution of a cationic surfactant (B), the polyester (A) is preferably added to the cationic surfactant (B) topically in an excess amount for preventing aggregation of the polyester (A).

On the other hand, if an aqueous solution of a cationic surfactant (B) is added to an aqueous dispersion of a polyester (A), the polyester (A) aggregates, and thus, the aqueous emulsion of the polyester (A) cannot be produced.

Example of the method for adding an aqueous dispersion of a polyester (A) to an aqueous solution of a cationic surfactant (B) include a method of dropwise adding an aqueous dispersion of a polyester (A) to an aqueous solution of a cationic surfactant (B) using a dropping funnel and a method of mixing an aqueous dispersion of a polyester (A) and an aqueous solution of a cationic surfactant (B) using a tube or the like. A method of adding, dropwise, an aqueous dispersion of a polyester (A) to an aqueous soap solution of a cationic surfactant (B) is preferred.

The addition of an aqueous dispersion of a polyester (A) to an aqueous solution of a cationic surfactant (B) is preferably performed with stirring.

When an aqueous dispersion of a polyester (A) is added to the soap solution of a cationic surfactant (B) with stirring, the stirring speed is, from the viewpoint of increasing the dispersion stability of the aqueous emulsion of the polyester (A), preferably ≥300 rpm, more preferably ≥350 rpm, further preferably ≥400 rpm, and preferably ≤600 rpm, more preferably ≤550 rpm, further preferably ≤500 rpm.

The temperature in adding an aqueous dispersion of a polyester (A) to an aqueous solution of a cationic surfactant (B) is, from the viewpoint of increasing the dispersion stability of the aqueous emulsion of the polyester (A), preferably ≥10° C., more preferably ≥15° C., and preferably ≤70° C., more preferably ≤60° C., further preferably ≤55° C.

The zeta potential of particles containing the polyester (A) after adding an aqueous dispersion of a polyester (A) to an aqueous solution of a cationic surfactant (B) is preferably a positive value.

### <Aqueous Dispersion of Polyester (A)>

In an aqueous dispersion of a polyester (A), the zeta potential of the polyester (A) before addition to a soap solution of the cationic surfactant (B) has a negative value. Accordingly, polyester (A) is preferably previously neutralized with a basic compound.

The zeta potential of polyester (A) is a potential of the shear plane of particles of the polyester (A), and can be measured by a method described in the section of Examples.

Examples of the basic compound used for neutralizing polyester (A) include a metal basic compound and a non-metal basic compound.

Each of the basic compounds may be used alone or two or more thereof may be used.

Examples of the metal basic compound include a hydroxide, a carbonate, and a phosphate of an alkali metal, such as lithium, sodium, and potassium, and a hydroxide, a carbonate, and a phosphate of an alkaline earth metal, such as magnesium and calcium.

Examples of the non-metal basic compound include ammonia and an organic amine compound.

The organic amine compound is a compound having at least one primary amino group, secondary amino group, or tertiary amino group. The organic amine compound may contain a functional group other than the amino groups. An example of the functional group is a hydroxy group.

Examples of the organic amine compound include a primary, secondary, or tertiary aliphatic amine and an alkanolamine having at least one amino group and at least one hydroxy group.

Specific examples of the aliphatic amine include alkylamines having ≥2 and ≤8 carbon atoms, such as trimethylamine, ethylamine, diethylamine, and triethylamine.

Specific examples of the alkanolamine include alkanolamines having ≥2 and ≤8 carbon atoms which are compatible with water, for example, primary alkanolamines, such as monoethanolamine, isopropanolamine, and isobutanolamine; secondary alkanolamines, such as N-methylethanolamine, N-ethylethanolamine, N-methylpropanolamine, diethanolamine, and diisopropanolamine; and tertiary alkanolamines, such as N,N-dimethylethanol amine, N,N-dimethylpropanolamine, N,N-diethylethanolamine, N-ethyldiethanolamine, N-methyldiethanolamine, triethanolamine, and triisopropanolamine.

Among them, as the basic compound, an alkali metal hydroxide and an alkylamine are preferred, and sodium hydroxide, potassium hydroxide, and triethylamine are more preferred.

The equivalent of the basic compound used may be any that gives a zeta potential of the polyester (A) of a negative value and is preferably ≥80% and ≤95%.

The equivalent of the basic compound used can be determined by the following calculation formula (1). When the equivalent of the basic compound used is ≤100%, the equivalent has the same meaning as the neutralization degree. When the equivalent of the basic compound used exceeds 100% in the following formula, this means that the basic compound is excessive relative to the acid group of the polyester (A), and the neutralization degree of the polyester (A) at this time is considered as 100%.

$$Equivalent of basic compound used ( \% ) = \{ 56.1 ( g / mol ) / molar mass of basic compound ( g / mol ) \} \times [ \{ mass of basic compound added ( g ) \times 0.01 \times weight concentration of basic compound ( \% ) \} / \{ 0.001 \times mass of polyester ( A ) ( g ) \times acid value of polyester ( A ) ( mgKOH / g ) \} ]$$

When the equivalent of the basic compound used exceeds 100%, the cationic surfactant (B) is consumed by the basic compound in adding an aqueous dispersion of the polyester (A) to an aqueous solution of the cationic surfactant (B), which is not preferred.

The aqueous medium is a dispersion medium in which water occupies the most proportion by mass. The water content in the aqueous medium is, from the viewpoint of the weather resistance, preferably ≥80% by mass or more, more preferably ≥90% by mass, further preferably ≥95% by mass, and preferably ≤100% by mass, more preferably 100% by mass.

Examples of components other than water include organic solvents that dissolve in water, for example, alkyl alcohols having ≥1 or more and ≤5 carbon atoms, such as methanol, ethanol, and isopropanol; dialkyl ketones having ≥3 and ≤5 carbon atoms, such as acetone and methyl ethyl ketone; and a cyclic ether, such as tetrahydrofuran.

The aqueous medium is preferably essentially constituted of water.

Examples of the organic solvent for dissolving the polyester (A) include ketone solvents, for example, dialkyl ketones having an alkyl group having ≥1 and ≤3 carbon atoms, such as acetone and methyl ethyl ketone; ether solvents, such as dibutyl ether and tetrahydrofuran; ester solvents, such as ethyl acetate and isopropyl acetate; and halogenated alkyl solvents, such as dichloromethane and chloroform. Among them, from the viewpoint of dissolving the polyester (A) and being easily removed from the emulsion, the organic solvent is preferably a dialkyl ketone having an alkyl group having ≥1 and ≤3 carbon atoms, such as acetone and methyl ethyl ketone, more preferably methyl ethyl ketone.

The mass ratio of the organic solvent to the polyester (A) [organic solvent/polyester (A)] is, from the viewpoint of dissolving the polyester (A) to facilitate the phase inversion to an aqueous medium and the viewpoint of more increasing the dispersion stability of the aqueous dispersion of particles of the polyester (A), preferably ≥50/100, more preferably ≥70/100, further preferably ≥100/100, and preferably ≤300/100, more preferably ≤200/100.

When the polyester (A) is neutralized with the basic compound, it is preferred that, after preparing a solution of the polyester (A), an aqueous solution of the basic compound is further added thereto to neutralize the polyester (A).

A dissolving operation of the polyester (A) in an organic solvent and the subsequent addition of an aqueous solution of the basic compound are generally performed at a temperature of the boiling point of the organic solvent or lower.

The amount of the aqueous medium added is, from the viewpoint of increasing the productivity of the aqueous dispersion of the polyester (A), relative to 100 parts by mass of a resin component that constitutes resin particles, preferably ≥50 parts by mass, more preferably ≥100 parts by mass, further preferably ≥200 parts by mass, and preferably ≤900 parts by mass, more preferably ≤500 parts by mass, further preferably ≤400 parts by mass.

From the viewpoint of increasing the dispersion stability of the aqueous dispersion of the polyester (A), the organic solvent is preferably removed, after phase inversion emulsification, from the aqueous dispersion obtained by the phase inversion emulsification.

The method for removing the organic solvent is not particularly limited, and any method can be used.

The resulting aqueous dispersion of the polyester (A) is preferably filtered with a metal net or the like to remove course particles and the like. In the case where the organic solvent is removed, water is reduced together with the organic solvent by azeotropy, and thus, water is then preferably added to adjust the solid concentration.

### [Aqueous Emulsion of Polyester (A)]

An aqueous emulsion of a polyester (A) according to an embodiment of the present invention contains a polyester (A) and a cationic surfactant (B), and particles containing the polyester (A) have a zeta potential of a positive value and a volume average particle diameter of 300 nm or less. The particles containing the polyester (A) are preferably particles containing the polyester (A) and the cationic surfactant (B), more preferably particles having a layer of the cationic surfactant (B) on the surface of the polyester (A).

The volume average particle diameter of the particles containing the polyester (A) in the aqueous emulsion of the polyester (A) is, from the viewpoint of increasing the dispersion stability of the aqueous emulsion of the polyester (A), ≤300 nm, preferably ≤250 nm, more preferably ≤220 nm, and preferably ≥20 nm, more preferably ≥100 nm, further preferably ≥150 nm.

The mass ratio of the cationic surfactant (B) to the polyester (A) (cationic surfactant (B)/polyester (A)) in the aqueous emulsion of the polyester (A) is preferably ≥10/100, more preferably ≥11/100, further preferably ≥12/100, and preferably ≤50/100, more preferably ≤40/100, further preferably ≤30/100.

An aqueous emulsion of polyester (A) according to an aspect of the present invention can be mixed with an asphalt to be used, for example, for producing an asphalt emulsion described later.

The resulting asphalt emulsion can be used, for example, after being dissolved with a solvent, such as water, or after being mixed with an aggregate, a filler, and the like, and can be suitably used for slurry sealing, micosurfacing, chip sealing, fog sealing, recycling (hot in-place, cold in-place), and the like.

### [Asphalt Emulsion]

Basic components of an asphalt emulsion according to an aspect of the present invention are an asphalt as an oil phase and the aqueous emulsion of the polyester (A) as an aqueous phase, and a polymer material may be added to the aqueous phase for increasing the durability of a film formed from the asphalt emulsion.

### <Asphalt>

As for the asphalt used in the asphalt emulsion, various performance grade (PG) asphalts can be used. The asphalt is selected based on some factors, such as a specific project requirement, weather conditions in the area, and the intended application. The asphalt is generally blended by using the PG grade (regulated according to AASHTO M 320) binder within but not limited to the following range: PG 52-XX to PG 76-XX.

The content of the asphalt relative to the total mass of the asphalt emulsion is preferably ≥40% by mass, more preferably ≥45% by mass, further preferably ≥50% by mass, and preferably ≤80% by mass, more preferably ≤75% by mass, further preferably ≤70% by mass.

### <Surfactant>

Examples of surfactant include a cationic surfactant, an anionic surfactant, an amphoteric surfactant, and a nonionic surfactant, and, from the viewpoint of adsorption to an aggregate, the surfactant is preferably a cationic surfactant.

Examples of the cationic surfactant include a mineral acid salt or a lower carboxylic acid salt of an amine, such as an alkylamine, an alkylpolyamine, an amideamine, or an alkylimidazoline, and a quaternary ammonium salt.

The preferred cationic surfactant is in a liquid form. For example, to make a flowable liquid, a solvent, such as water, a lower alcohol, glycol, and polyoxyethylene glycol, a saccharide, such as glucose and sorbitol, a lower fatty acid, a lower amine, a hydrotropic agent, such as p-toluenesulfonic acid and an ether carboxylic acid, or the like can be blended.

The content of the cationic surfactant is, from the economic perspective and from the viewpoint of achieving a superior storage stability, relative to total mass of the asphalt emulsion, preferably ≥0.02% by mass, more preferably ≥0.05% by mass, further preferably ≥0.10% by mass, and preferably ≤3.0% by mass, more preferably ≤2.5% by mass, further preferably ≤2.0% by mass.

### <Polymer Material>

The asphalt emulsion may contain a polymer material. Examples of the polymer material include thermoplastic elastomers, such as a styrene/butadiene rubber (SBR), a styrene/butadiene/block copolymer (SBS), a styrene/isoprene/block copolymer (SIS), and an ethylene/vinyl acetate copolymer (EVA); and thermoplastic resins, such as an ethylene/vinyl acetate copolymer, an ethylene/ethyl acrylate copolymer, polyethylene, and polypropylene.

The content of the polymer material in the asphalt emulsion is, from the viewpoints of fuel resistance and water abrasion resistance of asphalt pavement, preferably ≥0.1% by mass, more preferably ≥0.5% by mass, further preferably ≥1% by mass, and preferably ≤10% by mass, more preferably ≤5% by mass, further preferably ≤3% by mass.

### [Method for Producing Asphalt Emulsion]

The asphalt emulsion is preferably produced by a method of adding an asphalt to a mixture containing the aqueous emulsion of polyester (A), an aqueous medium, and a surfactant, and optionally containing a polymer material and the like (hereinafter also referred to as “optional components”) and mixing the asphalt and the mixture.

From the viewpoint of emulsifying ability, the mixing is preferably performed with an emulsifying apparatus, such as a colloid mill, a barrel-type homogenizer, a homogenizer, and a line mixer.

The temperature of the mixture of an aqueous medium, a surfactant, and optional components in adding an asphalt is, from the viewpoint of the emulsifying ability, preferably ≥25° C., more preferably ≥30° C., further preferably ≥35° C., and preferably ≤60° C., more preferably ≤55° C.

The pH of the mixture of an aqueous medium, a surfactant, and optional components in adding an asphalt is, from the viewpoint of the emulsifying ability, preferably ≥1, more preferably ≥1.5, further preferably ≥1.8, and preferably ≤2.5, more preferably ≤2.2, further preferably ≤2.0. In other words, the content of an acid in the asphalt emulsion is such an amount that gives a pH of the mixture of an aqueous medium, a surfactant, and optional components within the above range.

The temperature of the asphalt added to the mixture of an aqueous medium, a surfactant, and optional components is, from the viewpoint of the emulsifying ability, preferably ≥120° C., more preferably ≥125° C., further preferably ≥130° C., and preferably ≤160° C., more preferably ≤155° C., further preferably ≤150° C.

The volume average particle diameter of particles containing an asphalt in the asphalt emulsion is, from the viewpoints of fuel resistance and water abrasion resistance of the asphalt pavement, preferably ≥0.1 μm, more preferably ≥0.5 μm, further preferably ≥0.8 μm, and from the viewpoint of the stability of the asphalt emulsion, preferably ≤2.5 μm, more preferably ≤2.0 m, further preferably ≤1.5 μm.

According to the present invention, it is possible to provide an aqueous emulsion of a polyester used in an asphalt emulsion for producing asphalt pavement having a superior fuel resistance and water abrasion resistance, and a method for producing the same.

### EXAMPLES

Various properties were measured and evaluated according to the methods described below.

In Examples and Comparative Examples below, parts and % are expressed by mass unless otherwise specified.

In Production Examples, Examples, and Comparative Examples below, “parts” and “%” are “parts by mass” and “% by mass” unless otherwise specified.

### (1) Method for Measuring Acid Value and Hydroxyl Value of Polyester (A)

The acid value and the hydroxyl value of polyester (A) were measured based on JIS K0070:1992. However, only the measurement solvent was changed from a mixed solvent of ethanol and ether defined in JIS K0070:1992 to a mixed solvent of acetone and toluene (acetone:toluene=1:1 (by volume)) for polyesters A-1 and A-2 and to a mixed solvent of chloroform and dimethylformamide (chloroform:dimethylformamide=7:3 (by volume)) for polyesters A-3 and A-4.

### (2) Methods for Measuring Softening Point and Glass Transition Temperature of Polyester (A)

### (i) Softening Point

Using a flow tester (“CFT-500D” manufactured by SHIMADZU CORPORATION), a load of 1.96 MPa was applied with a plunger to 1 g of a sample while heating the sample at a temperature increase rate of 6° C./minute to extrude the sample from a nozzle having a diameter of 1 mm and a length of 1 mm. The amount of descent of the plunger of the flow tester was plotted versus the temperature, and the temperature at the time when the half amount of the sample flowed out was taken as the softening point.

### (ii) Glass Transition Temperature

Using a differential scanning calorimeter (“Q-100” manufactured by TA Instruments Japan Inc.), 0.01 to 0.02 g of a sample was weighed into an aluminum pan, was heated to 200° C., and was then cooled from the temperature to 0° C. at a temperature decrease rate of 10° C./minute. Next, while increasing the temperature to 150° C. at a temperature increase rate of 10° C./minute, the calories were measured.

Among the observed endothermic peaks, the temperature of a peak having the largest peak area was taken as the endothermic maximum peak temperature. When no peak was observed but only a step was observed, the temperature of the point at which the tangential line having the maximum inclination of the curve in the step region intersects with the extension of the baseline on the lower temperature side of the step was taken as the glass transition temperature.

### Method for Measuring Number Average Molecular Weight and Weight Average Molecular Weight of Polyester (A)

The molecular weight distribution was measured by a gel permeation chromatography (GPC) method obtained by the following method to determine the number average molecular weight and the weight average molecular weight.

### (i) Preparation of Sample Solution

A sample was dissolved in a solvent at 25° C. for a concentration of 0.5 g/100 mL. Subsequently, the solution was filtered with a fluororesin filter having a pore size of 0.2 μm (“DISMIC-25JP” manufactured by TOYO ROSHI KAISHA, LTD.) to remove insoluble matter, thereby preparing a sample solution.

As the solvent, chloroform was used for polyesters A-1 and A-2 and tetrahydrofuran was used for polyesters A-3 and A-4.

### (ii) Measurement of Molecular Weight

The measurement apparatus and analytical column described below were used, and the same solvent as used for preparing the sample solution was allowed to flow as an eluent at a flow rate of 1 mL per minute to stabilize the column in a thermostat of 40° C. Into the column, 100 μL of the sample solution was injected to perform measurement. The molecular weight of the sample was calculated based on a calibration curve created in advance. Here, the calibration curve used was created using the following several monodisperse polystyrenes as standard samples: “A-500” (5.0×10²), “A-1000” (1.01×10³), “A-2500” (2.63×10³), “A-5000” (5.97×10³), “F-1” (1.02×10³), “F-2” (1.81×10⁴), “F-4” (3.97×10⁴), “F-10” (9.64×10⁴), “F-20” (1.90×10⁵), “F-40” (4.27×10⁵), “F-80” (7.06×10⁵), “F-128” (1.09×10⁶) (all manufactured by TOSOH CORPORATION).

Measurement apparatus: “HLC-8220CPC” (manufactured by TOSOH CORPORATION)

Analytical column: “GMHXL”+“G3000HXL” (manufactured by TOSOH CORPORATION)

### (4) Method for Measuring Zeta Potential and Volume Average Particle Diameter of Particles of Polyester (A) and Particles Containing Polyester (A)

Into a 100-mL beaker, 15 mL of deionized water was poured, subsequently, 0.2 mL of an aqueous dispersion of a polyester (A) or an aqueous emulsion of a polyester (A) was added thereto, followed by sufficient stirring. The prepared diluted solution of the aqueous dispersion of the polyester (A) or the aqueous emulsion of the polyester (A) was put into a cell of a nano-particle diameter measurement apparatus (NANOTRAC WAVE II manufactured by MICROTRAC MRB) to fill the cell. After confirming indication of “Detectable Concentration” on a display of the nano-particle diameter measurement apparatus, measurement with a dynamic light scattering (DLS) analyzer was started to measure the volume average particle diameter and zeta potential of particles of the polyester (A) and particles containing the polyester (A).

### (5) Method for Evaluating Water Abrasion Resistance (Wet Track) of Asphalt Emulsion

In a mixing bowl, 800 g of an aggregate (Type II manufactured by Gordonville, water content: 3% by weight) that passed through a sieve of No. 4 (4.75 mm) and 5.8 g of a cement powder were sufficiently mixed. To the mixture, 23.2 g of water was added and was mixed until the entire mixture became uniform. To the resulting mixture, 93.1 g of an asphalt emulsion was put, and was mixed for 30 seconds until the entire mixture became uniform, and the mixture was quickly cast into the upper half of a mold. Within 15 seconds after casting the mixture in the mold, the mixture was molded with a mold strike off apparatus. After the mold was slowly released, the molded product (specimen) was stored in an oven set to 60° C. for ≥15 hours and ≥30 hours for drying. The specimen was taken out of the oven, and cooled down to room temperature (25° C.), thus producing a sample having a diameter of 10 inches and a thickness of ¼ inches. The weight of the sample, this time, was recorded as initial mass. The specimen was then immersed in water and placed in an oven set at 40° C. for 24 hours. The specimen was removed out from water, and placed in the abrasion tester pan (Benedict Wet Track Abrasion Tester N-50 manufactured by Berglamp) and clipped. Water at 40° C. was added into the pan to the height about 0.25 inches above the upper surface of the specimen. The abrasion test was performed with a rotation movement of a rubber tube in contact with the surface of the specimen at the lowest speed. After 5 minutes, the rotation was stopped, and the specimen is removed from the pan. The surface of the specimen is cleaned with a brush to remove any generated debris. The specimen was then dried in an oven at 60° C. for 5 hours. Weigh out the dried sample and calculate the mass loss (% by mass) as the difference between the mass of the sample after drying and the initial mass. A lower mass loss indicates a better water abrasion resistance.

### (6) Method for Evaluating Fuel Resistance of Asphalt Emulsion

In a mixing bowl, 800 g of an aggregate (Type II manufactured by Gordonville, water content: 3% by weight) that passed through a sieve of No. 4 (4.75 mm) and 5.8 g of a cement were sufficiently mixed. To the mixture, 23.2 g of water was added, and was mixed until the entire mixture became uniform. To the mixture, 93.1 g of an asphalt emulsion was added and mixed for 30 seconds until the entire mixture became uniform. The mixture was quickly cast into the mold. Within 15 seconds after casting the mixture, it was molded with a mold strike off apparatus. After the mold was slowly released, the specimen was stored in an oven set to 60° C. for ≥15 hours and ≤30 hours for drying. The specimen was taken out of the oven, and cooled down to room temperature (25° C.), thus producing a specimen having a diameter of 10 inches and a thickness of ¼ inches. The specimen is then immersed in about 2 inches height of kerosene for 15 minutes at room temperature. The sample was removed from the kerosene and dried using a fan for 48 hours at a room temperature. The mass of the dry specimen was recorded as initial mass. The specimen was placed in the abrasion tester pan (Benedict Wet Track Abrasion Tester N-50 manufactured by Berglamp) and clipped. An abrasion test was performed with a rotation movement of a rubber tube in contact with the surface of the specimen at the lowest speed. After 2 minutes, the rotation was stopped, the sample was removed from the pan. The surface of the specimen was cleaned with a brush to remove any debris and their mass recorded. The fuel resistance (% mass loss) was calculated as the mass difference between the mass after the abrasion test and the initial mass. A lower mass loss indicates a better fuel resistance.

### [Production of Polyester (A)]

### Production Example 1 (Production of Polyester A-1)

A polyoxypropylene(2.2) adduct of bisphenol A, terephthalic acid, and polyethylene terephthalate (manufactured by UNIFI, 100% Post Consumer rPET Resin|500 Mesh Filtered Round|Bright 10.68 IV|Crystallized) which are shown in Table 1 were put in a 10-L four-neck flask equipped with a nitrogen introducing pipe, a dewatering conduit, a stirrer, a thermometer, and a thermocouple and were heated to 120° C. An esterification catalyst and an esterification promoter which are shown in Table 1 were put at 120° C. and then, the temperature was quickly increased to 235° C. Then, while keeping the temperature at 235° C. for 4 hours, the reaction system was thoroughly stirred. After a reaction for 4 hours, the temperature was decreased to 185° C. Then, dodecenylsuccinic anhydride shown in Table 1 was put, and the temperature was increased to 220° C. at 10° C./30 minutes. The mixture was then reacted at 220° C. and 100 torr for about 2 hours until the softening point shown in Table 1 was achieved to thus produce a polyester A-1. The polyester A-1 was evaluated by the evaluation methods as described above. The results are shown in Table 1.

### Production Example 2 (Production of Polyester A-2)

Polyester A-2 was produced in the same manner as in Production Example 1 except for changing the raw materials of the polyester and the amounts thereof to those shown in Table 1. The polyester A-2 was evaluated by the evaluation methods as described above. The results are shown in Table 1.

### Production Example 3 (Production of Polyester A-3)

A polyoxypropylene(2.2) adduct of bisphenol A, terephthalic acid, and polyethylene terephthalate (manufactured by UNIFI, 100% Post Consumer rPET Resin|500 Mesh Filtered Round|Bright 10.68 IV|Crystallized) which are shown in Table 1 were put in a 10-L four-neck flask equipped with a nitrogen introducing pipe, a dewatering conduit, a stirrer, a thermometer, and a thermocouple, and were heated to 160° C. to dissolve the components. Raw monomers of the addition polymer segment containing butyl acrylate and 4-tert-butylcatechol shown in Table 1 were added dropwise with a dropping funnel over 1 hour while keeping the temperature of the reaction system at 160° C.±3° C. Stirring was continued for 1 hour while keeping the temperature at 160° C. to polymerize the raw monomers. Then, the resultant was stirred at 8.3 kPa for 1 hour to remove unreacted raw monomers of the addition polymer segment. Then, tin (II) 2-ethylhexanoate was added, the temperature was increased to 230° C. and was kept for 8 hours, and then, was decreased to 185° C. Dodecenylsuccinic anhydride was put at 185° C., and the temperature was increased to 220° C. at 10° C./30 minutes. Then, the mixture was reacted at 220° C. and 100 torr for about 3 hours until the softening point shown in Table 1 was achieved, thus producing a polyester (A-3). The polyester A-3 was evaluated by the evaluation methods as described above. The results are shown in Table 1.

### Production Example 4 (Production of Polyester A-4)

Alcohol components and carboxylic acid components other than trimellitic anhydride which are shown in Table 1 were put in a 10-L four-neck flask equipped with a nitrogen introducing pipe, a dewatering conduit, a stirrer, a thermometer, and a thermocouple, and were heated to 160° C. to dissolve the components. Raw monomers of the addition polymer segment containing acrylic acid and 4-tert-butylcatechol which are shown in Table 1 were added dropwise with a dropping funnel over 1 hour while keeping the temperature of the reaction system at 160° C.±3° C. Stirring was continued for 1 hour while keeping the temperature at 160° C. to polymerize the raw monomers and acrylic acid, and then, the resultant was stirred at 8.3 kPa for 1 hour. Then, tin (II) 2-ethylhexanoate was added, the temperature was increased to 230° C. and was kept for 6.5 hours, and a reaction was continued at 230° C. under a reduced pressure at 8.3 kPa for 1 hour. Then, trimellitic anhydride was put at 215° C., and the mixture was reacted at 210° C. and 40 kPa until the softening point shown in Table 1 was achieved, thus producing a polyester A-4. The polyester A-4 was evaluated by the evaluation methods as described above. The results are shown in Table 1.

TABLE 1

| | | | Production Example | | | | | | | |
|---|---|---|---|---|---|---|---|---|---|---|
| | | | 1 | | 2 | | 3 | | 4 | |
| | | | Polyester (A) | | | | | | | |
| | | | A-1 | | A-2 | | A-3 | | A-4 | |
| | | | Charged | | Charged | | Charged | | Charged | |
| | | | amount | Molar | amount | Molar | amount | Molar | amount | Molar |
| | | | (g) | ratio *3 | (g) | ratio *3 | (g) | ratio *3 | (g) | ratio *3 |
| Raw material of | Alcohol | BPA-PO Adduct *1 | 3517 | 40.0 | 3572 | 40.0 | 2814 | 40.0 | 3271 | 70.0 |
| polyester/polyester | component | BPA-EO Adduct *2 | 0 | 0 | 0 | 0 | 0 | 0 | 1302 | 30.0 |
| segment | Carboxylic acid | Terephthalic acid | 984 | 23.6 | 773 | 18.24 | 787 | 23.6 | 1020 | 46.0 |
| | componen | Dodecenyl-succinic | 605 | 9.4 | 470 | 7.2 | 484 | 9.4 | 615 | 18.0 |
| | | anhydride | | | | | | | | |
| | | Trimellitic anhydride | 0 | 0 | 245 | 5.0 | 0 | 0 | 564 | 22.0 |
| | Polyethylene terephthalate | | 2894 | 60.0 | 2940 | 60.0 | 2315 | 60.0 | 0 | 0 |
| Bireactive monomer | | Acrylic acid | 0 | 0 | 0 | 0 | 0 | 0 | 29 | 3.0 |
| | | Butyl acrylate | 0 | 0 | 0 | 0 | 620 | 4.8 | 0 | 0 |
| Raw material of | Raw material | Styrene | 0 | 0 | 0 | 0 | 929 | 8.9 | 882 | 8.5 |
| addition polymer | monomer | 2-Ethylhexyl | 0 | 0 | 0 | 0 | 0 | 0 | 168 | 0.9 |
| segment | | acrylate | | | | | | | | |
| | Radical | Di-tert- | 0 | 0 | 0 | 0 | 56 | 0.4 | 84 | 0.6 |
| | polymerization | butylperoxide | | | | | | | | |
| | initiator | | | | | | | | | |
| | | | Charged | | Charged | | Charged | | Charged | |
| | | | amount | Mass | amount | Mass | amount | Mass | amount | Mass |
| | | | (g) | ratio *4 | (g) | ratio *4 | (g) | ratio *4 | (g) | ratio *4 |
| Esterification | Tin (II) di(2-ethylhexanoate) | | 40.0 | 0.5 | 40.0 | 0.5 | 32.0 | 0.5 | 34.0 | 0.5 |
| catalyst | | | | | | | | | | |
| Esterification | Gallic acid | | 4.2 | 0.05 | 0 | 0 | 0 | 0 | 0 | 0 |
| promoter | | | | | | | | | | |

| | | | | | |
|---|---|---|---|---|---|
| Properties | Softening point /Tm (° C.) | 103 | 117 | 102 | 112 |
| | Glass transition temperature /Tg (° C.) | 59 | 63 | 52 | 60 |
| | Acid value (mgKOH/g) | 7 | 7 | 7 | 24 |
| | Hydroxyl value (mgKOH/g) | 26 | 29 | 20 | 28 |
| | Number average molecular weight Mn | 3,100 | 4,000 | 3,000 | 2,360 |
| | Weight average molecular weight Mw | 8,500 | 26,000 | 27,000 | 46,200 |

| | | | | |
|---|---|---|---|---|
| PET Ratio in polyester resin (A) (% by weight) *4 | 36% | 37% | 29% | 0% |

*1: BPA-PO Adduct: polyoxypropylene(2.2) adduct of bisphenol A
*2: BPA-EO Adduct: polyoxyethylene(2.2) adduct of bisphenol A
*3: Molar ratio relative to total of alcohol component and ethylene glycol units in PET taken as 100
*4: Proportion of mass relative to total of masses of all raw materials of polyester

### [Production of Aqueous Emulsion of Polyester (A)]

### Example 1-1 (Production of Aqueous Emulsion 1 of Polyester (A))

### (1) Production of Aqueous Dispersion of Polyester (A)

Into 20-L three-neck flask equipped with a reflux condenser, a stirrer, and a thermocouple, 3000 g of methyl ethyl ketone and 2000 g of the polyester A-1 were put, and the temperature was increased to 60° C. with stirring and stirring was continued until the polyester A-1 completely dissolved in methyl ethyl ketone. The temperature of the solution of the polyester A-1 was decreased to 50° C., and an aqueous 10% KOH solution was added in such an amount that gave a neutralization degree of the polyester A-1 of 90% by mole. Then, 2954 g of water at 50° C. was put therein, followed by stirring for 1 hour. Then, using a pump manufactured by MASTERFLEX, the solution was passed through a homogenizer (Magic LAB manufactured by IKA, set to a speed of 25,000 rpm) at a rate of about 400 mL and was poured into another 20-L container equipped with a stirrer. Similarly, the solution was passed again through a homogenizer (also set to a speed of 25,000 rpm) using a pump and was got back into the original 20-L three-neck flask. Into the solution of the polyester A-1, 2.5 g of sodium polyoxyethylene lauryl ether sulfate (EMAL E-27C manufactured by KAO CORPORATION, active ingredient concentration: 27% by mass), 0.6 g of an antifoaming agent (XIAMETER AFE-1520 manufactured by Dow, active ingredient concentration: 20% by mass), and 750 g of an aqueous solution of 1.5 g of a bactericide (KORDEK MLX manufactured by ChemPoint) were poured. Then, a distillation pipe and a trap were put on the 20-L container so that methyl ethyl ketone can be evaporated, and the pressure was reduced to 80 to 150 torr at 40° C. with a vacuum pump to distill methyl ethyl ketone until the concentration of methyl ethyl ketone became 100 ppm or less. Then, the solid concentration was adjusted to 40% by mass to thus produce an aqueous dispersion 1 of the polyester (A). The volume average particle diameter and zeta potential of the particles of the polyester A-1 in the aqueous dispersion 1 of the polyester (A) were evaluated by the evaluation methods as described above. The results are shown in Table 2.

### (2) Production of Aqueous Emulsion of Polyester (A)

To a 2-L flask containing 160 g of an aqueous solution in which 40 g of N,N,N,N′,N′-pentamethyl-N′-tallow alkyltrimethylenedi-, dichloride (active ingredient concentration: 50% by mass) was dissolved, 800 g of the aqueous dispersion 1 of the polyester (A) was dropwise added with stirring at 450 rpm at 25° C. over 30 minutes to produce an aqueous emulsion 1 of the polyester (A). The volume average particle diameter and zeta potential of the particles containing the polyester A-1 in the aqueous emulsion 1 of the polyester (A) were evaluated by the evaluation methods as described above. The results are shown in Table 2.

### Examples 1-2 to 1-6 (Production of Aqueous Emulsions 2 to 6 of Polyester (A))

Aqueous dispersions 2 to 6 of the polyester (A) and aqueous emulsions 2 to 6 of the polyester (A) were produced in the same manner as in Example 1-1 except for changing the polyester (A) and the base and the amount thereof to those shown in Table 2. The volume average particle diameters and zeta potentials of the particles of the polyester (A) in the aqueous dispersions 2 to 6 of the polyester (A) and the particles containing the polyester (A) in the aqueous emulsions 2 to 6 of the polyester (A) were evaluated by the evaluation methods as described above. The results are shown in Table 2.

### Example 1-7

Into a 600-mL beaker, 354 g of water was put and was heated to 40° C. to 50° C. Then, the beaker was placed on a hot plate, and while keeping the temperature at 40° C. to 50° C., 4 g of N,N,N,N′,N′-pentamethyl-N′-tallow alkyltrimethylenedi-, dichloride (active ingredient concentration: 50% by mass) and 15 g of a cationic surfactant (Asfier N480L manufacture by KAO CORPORATION) were put therein, and were stirred with a magnetic stirrer until the cationic surfactant was uniformly dissolved. With stirring at 450 rpm, 40 g of the aqueous dispersion 1 of the polyester (A) produced in Example 1-1 was added dropwise over 30 seconds to thus produce an aqueous emulsion 7 of the polyester (A).

### Comparative Example 1 (Production of Aqueous Emulsion C1 of Polyester (A))

An aqueous dispersion 1 of the polyester (A) was produced in the same manner as in Example 1-1. While stirring the aqueous dispersion 1 of the polyester (A), 160 g of an aqueous solution in which 40 g of N,N,N,N′,N′-pentamethyl-N′-tallow alkyltrimethylenedi-, dichloride (active ingredient concentration: 50% by mass) was dissolved was added dropwise into the aqueous dispersion 1 of the polyester (A). Then, particles of the polyester (A) aggregated and precipitated to thus fail to obtain an aqueous emulsion of the polyester (A).

TABLE 2

| | | Aqueous dispersion | | | | | | | Aqueous emulsion | |
|---|---|---|---|---|---|---|---|---|---|---|
| | | | | | | | Evaluation | | Evaluation | |
| | | | | | | | Volume | | Volume | |
| | | | | Base | | | average | | average | |
| | Aqueous | Polyester (A) | | | Content | Neutralization | particle | Zeta | particle | Zeta |
| | emulsion of | | Acid value | | (parts by | degree | diameter | potential | diameter | potential |
| | polyester (A) | Kind | (mgKOH/g) | Kind | mass)*1 | (%)*2 | (nm) | (mV) | (nm) | (mV) |
| Example 1-1 | 1 | A-1 | 7 | 10% KOH | 63 | 90 | 200 | −30 | 200 | +30 |
| Example 1-2 | 2 | A-2 | 7 | 10% KOH | 63 | 90 | 210 | −30 | 210 | +30 |
| Example 1-3 | 3 | A-3 | 7 | 10% KOH | 63 | 90 | 180 | −30 | 180 | +30 |
| Example 1-4 | 4 | A-4 | 24 | 10% KOH | 168 | 70 | 160 | −40 | 160 | +40 |
| Example 1-5 | 5 | A-1 | 7 | 10% NaOH | 45 | 90 | 210 | −35 | 210 | +35 |
| Example 1-6 | 6 | A-1 | 7 | 98% TEA *3 | 13 | 100 | 220 | −30 | 220 | +30 |
| Example 1-7 | 7 | A-1 | 7 | 10% KOH | 63 | 90.0 | 200 | −30 | 200 | +20 |

*1Proportion relative to 1000 parts by mass of polyester (A)
*2Equivalent (% by mole) used relative to acid value of polyester (A)
*3: Triethylamine

### [Production of Asphalt Emulsion]

### Example 2-1 (Production of Asphalt Emulsion 1)

Into a 600-mL beaker, 354 g of water was put and was heated to 40° C. to 50° C. Then, the beaker was placed on a hot plate, and while keeping the temperature at 40° C. to 50° C., 15 g of a cationic surfactant (Asfier N480L manufacture by KAO CORPORATION) and 15 g of hydrochloric acid were put therein. The mixture was stirred with a magnetic stirrer until the cationic surfactant was uniformly dissolved. After the cationic surfactant dissolved, 30 g of an SBR emulsion (UP1159 manufactured by ULTRAPAVE, solid concentration: 65% by mass) and 40 g of the aqueous emulsion 1 of the polyester (A) were added and stirring was continued. After achieving a uniform state, the pH of the aqueous dispersion was measured, and hydrochloric acid was added as needed to adjust the pH to 1.8 to 2.0. The magnetic stirrer was removed, and the resultant was used as a soap solution.

Into a circulation type colloid mill (manufactured by ALPHA Laboratory Equipment), the soap solution was poured, and the switch of the colloid mill was turned on to circulate the solution, and 591 g of an asphalt (PG 64-22 manufactured by Associated Asphalt) heated to 140° C. was slowly poured over about 1 minute. The mixture was mixed with the colloid mill for 2 minutes to 2.5 minutes after pouring of the asphalt started and cooled down to room temperature. Water was added as needed to adjust the solid concentration, thus producing an asphalt emulsion 1 having a solid concentration of about 62% by mass. The volume average particle diameter of the particles containing the asphalt in the asphalt emulsion 1 and the in-water abrasion resistance (wet track) and fuel resistance of asphalt pavement constructed with the asphalt emulsion 1 were evaluated by the evaluation methods as described above. The results are shown in Table 3.

### Examples 2-2 to 2-6 (Production of Asphalt Emulsions 2 to 6)

Asphalt emulsions 2 to 7 were produced in the same manner as in Example 2-1 except for changing the aqueous emulsion 1 of the polyester (A) to the aqueous emulsions of the polyester (A) shown in Table 3. The volume average particle diameter of the particles containing the asphalt in each asphalt emulsion and the in-water abrasion resistance (wet track) and fuel resistance of asphalt pavement constructed with each asphalt emulsion were evaluated by the evaluation methods as described above. The results are shown in Table 3.

### Examples 2-7 (Production of Asphalt Emulsion 7)

Into 413 g of the aqueous emulsion 7 of the polyester (A), 15 g of hydrochloric acid was put, and the mixture was stirred with a magnetic stirrer for 30 minutes. Then, 30 g of an SBR emulsion (UP1159 manufactured by ULTRAPAVE, solid concentration: 65% by mass) was added and the stirring was continued. After achieving a uniform state, the pH of the aqueous dispersion was measured and hydrochloric acid was added as needed to adjust the pH to 1.8 to 2.0. The magnetic stirrer was removed, and the resultant was used as a soap solution. Into a circulation type colloid mill (manufactured by ALPHA Laboratory Equipment), the surfactant solution was poured, and the switch of the colloid mill was turned on to circulate the solution, and 591 g of an asphalt (PG 64-22 manufactured by Associated Asphalt) heated to 140° C. was slowly poured over about 1 minute. The mixture was mixed with the colloid mill for 2 minutes to 2.5 minutes after pouring of the asphalt started, and was cooled to a room temperature, thus producing an asphalt emulsion 7 having a solid concentration of about 62% by mass. Water was added as needed to adjust the solid concentration. The volume average particle diameter of the particles containing the asphalt in the asphalt emulsion 7 and the in-water abrasion resistance (wet track) and fuel resistance of the asphalt emulsion 7 were evaluated by the evaluation methods as described above. The results are shown in Table 3.

### Examples 2-8 (Production of Asphalt Emulsion 8)

An asphalt emulsion 8 was produced in the same manner as in Example 2-1 except for changing the asphalt to PG 58-28 (manufactured by Associated Asphalt). The volume average particle diameter of the particles containing the asphalt in the asphalt emulsion 8 and the water abrasion resistance (wet track) and fuel resistance of asphalt pavement constructed with the asphalt emulsion 8 were evaluated by the evaluation methods as described above. The results are shown in Table 3.

### Comparative Example 2 (Production of Asphalt Emulsion C1)

An asphalt emulsion C1 was produced in the same manner as in Example 2-1 except for not using the aqueous emulsion 1 of the polyester (A) and changing the amount of the asphalt to 604 g and the amount of water to 381 g. The volume average particle diameter of the particles containing the asphalt in the asphalt emulsion C1 and the water abrasion resistance (wet track) and fuel resistance of asphalt pavement constructed with the asphalt emulsion C1 were evaluated by the evaluation methods as described above. The results are shown in Table 3.

TABLE 3

| | | Evaluation | | |
|---|---|---|---|---|
| | Aqueous | | Wet | Fuel |
| | emulsion of | Volume average | track | resistance |
| | polyester | particle diameter | (mass | (mass |
| | (A) | (μm) | loss %) | loss %) |
| Example 2-1 | 1 | 1 | 0.4 | 11 |
| Example 2-2 | 2 | 1 | 0.3 | 12 |
| Example 2-3 | 3 | 1 | 1.5 | 20 |
| Example 2-4 | 4 | 1 | 3.1 | 31 |
| Example 2-5 | 5 | 1 | 0.6 | 12 |
| Example 2-6 | 6 | 1 | 0.9 | 13 |
| Example 2-7 | 7 | 1 | 0.5 | 13 |
| Example 2-8 | 1 | 1 | 0.4 | 15 |
| Comparative | C1 | 1 | 4.2 | ND *1 |
| Example 2 | | | | |

*1: Unmeasurable due to breaking of sample

It can be seen in Table 3 that the asphalt pavement constructed with asphalt emulsions produced with the aqueous emulsions 1 to 7 of the polyester (A) obtained by the production method of the present invention has a superior fuel resistance and in-water abrasion resistance (wet track).

On the other hand, it can be seen that the asphalt pavement constructed with an asphalt emulsion produced with the aqueous emulsion C1 of the polyester (A) is inferior in the water abrasion resistance (wet track) and has a very low fuel resistance.

1. A method for producing an aqueous emulsion of a polyester (A) comprising adding an aqueous dispersion of a polyester (A) to a soap solution of a cationic surfactant (B),
the polyester (A) in the aqueous dispersion having a negative value zeta potential.

2. An aqueous emulsion of a polyester (A) comprising a polyester (A) and a cationic surfactant (B),
particles containing the polyester (A) having a positive value zeta potential and a volume average particle diameter of ≤300 nm.

3. The method for producing an aqueous emulsion of a polyester (A) according to claim 1, wherein adding the aqueous dispersion of the polyester (A) to the soap solution of a cationic surfactant (B) with stirring.

4. The method for producing an aqueous emulsion of a polyester (A) according to claim 3, wherein the stirring speed of the soap solution of a cationic surfactant (B) is ≥300 rpm and ≤600 rpm.

5. The method for producing an aqueous emulsion of a polyester (A) according to claim 1, wherein a temperature in adding an aqueous dispersion of a polyester (A) to an aqueous solution of a cationic surfactant (B) is ≥10° C. and ≤70° C.

6. The method for producing an aqueous emulsion of a polyester (A) according to claim 1, wherein a mass ratio of the cationic surfactant (B) to the polyester (A) (cationic surfactant (B)/polyester (A)) after adding the entire aqueous dispersion of the polyester (A) to the aqueous solution of the cationic surfactant (B) is ≥10/100 and ≤30/100.

7. The method for producing an aqueous emulsion of a polyester (A) according to claim 1, wherein a softening point of the polyester (A) is ≥20° C. and ≤140° C.

8. The method for producing an aqueous emulsion of a polyester (A) according to claim 1, wherein a glass transition temperature of the polyester (A) is ≥10° C. and ≤90° C.

9. The method for producing an aqueous emulsion of a polyester (A) according to claim 1, wherein an acid value of the polyester (A) is ≥4 mgKOH/g and ≤50 mgKOH/g.

10. The method for producing an aqueous emulsion of a polyester (A) according to claim 1, wherein a weight average molecular weight Mw of the polyester (A) is ≥5,000 and ≤100,000.

11. The method for producing an aqueous emulsion of a polyester (A) according to claim 1, wherein the polyester (A) is neutralized with a basic compound selected from one or more of an alkali metal hydroxide and an alkylamine.

12. The method for producing an aqueous emulsion of a polyester (A) according to claim 1, wherein an equivalent of the basic compound used is ≥80% and ≤95%.

13. The method for producing an aqueous emulsion of a polyester (A) according to claim 1, wherein the cationic surfactant (B) has at least one quaternary ammonium salt moiety in its molecule.

14. The aqueous emulsion of a polyester (A) comprising a polyester (A) and a cationic surfactant (B) according to claim 2, wherein the volume average particle diameter of the particles containing the polyester (A) is ≥20 nm and ≤300 nm.

15. The aqueous emulsion of a polyester (A) comprising a polyester (A) and a cationic surfactant (B) according to claim 2, wherein a mass ratio of the cationic surfactant (B) to the polyester (A) (cationic surfactant (B)/polyester (A)) after adding the entire aqueous dispersion of the polyester (A) to the aqueous solution of the cationic surfactant (B) is ≥10/100 and ≤50/100.

16. A method for producing an asphalt emulsion comprising adding the asphalt to the mixture containing the aqueous emulsion of polyester (A) produce by the method according to claim 1, an aqueous medium, a surfactant, and optional component, and mixing them.

17. A method for producing an asphalt emulsion according to claim 16, wherein, in adding the asphalt, a temperature of the mixture is ≥25° C. and ≤60° C.

18. A method for producing an asphalt emulsion according to claim 16, wherein, in adding the asphalt, a temperature of the asphalt is ≥120° C. and ≤160° C.

19. A method for producing an asphalt emulsion according to claim 16, wherein, the mixing is performed with an emulsifying apparatus selected from a colloid mill, a barrel-type homogenizer, a homogenizer, and a line mixer.
